(19) United States
(12) Patent Application Publication
(10) Pub. No.: US 2016/0355697 A1
(43) Pub. Date: Dec. 8, 2016

(54) LIQUID COMPOSITION AND IMAGE RECORDING METHOD

(71) Applicant: CANON KABUSHIKI KAISHA, Tokyo (JP)

(72) Inventors: Akiko Tominaga, Kawasaki-shi (JP); Takashi Imai, Kawasaki-shi (JP)

(21) Appl. No.: 15/161,601

(22) Filed: May 23, 2016

(30) Foreign Application Priority Data
Jun. 4, 2015 (JP) 2015-113886
Jun. 4, 2015 (JP) 2015-113887

(51) Int. Cl. C09D 11/38; C09D 11/322; C09D 11/328; B41J 2/01

(52) U.S. Cl. CPC C09D 11/38; B41J 2/01; C09D 11/322; C09D 11/328

(57) ABSTRACT

A liquid composition including a fluorinated nonionic surfactant and a water-soluble inclusion compound. The liquid composition can be used for forming images on a recording medium.

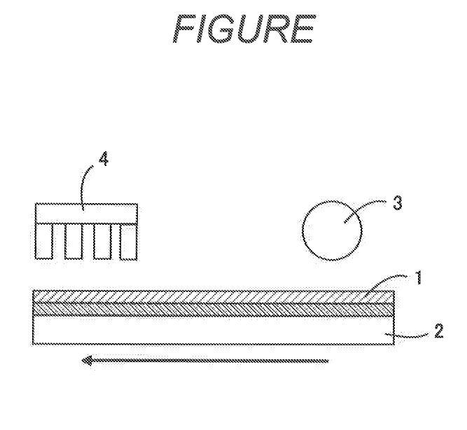

### BACKGROUND OF THE INVENTION

Field of the Invention

The present invention relates to a liquid composition and an image recording method using the liquid composition.

Description of the Related Art

The recent recording media for ink jet recording methods to record images include not only plain paper and paper exclusively for ink jet recording but also non-absorbable or poorly-absorbable recording media into which solvents in inks (liquid components) do not permeate or poorly permeate. If an ink commonly used in ink jet recording methods is applied to such a recording medium, a liquid component in the ink hardly permeates, and thus recorded images are likely to be blurred, for example.

The technique for overcoming such a problem is exemplified by a method of appropriately setting the physical properties of an ink in accordance with the characteristics of a recording medium. For example, an ink containing a fluorinated surfactant or a silicon-based surfactant and a compound having a siloxane structure has been disclosed. The ink has higher wettability on a non-absorbable or poorly-absorbable recording medium to suppress repelling (Japanese Patent Application Laid-Open No. 2014-077072).

### SUMMARY OF THE INVENTION

An aspect of the present invention provides an image recording method including a step of applying a liquid composition to a recording medium, the liquid composition containing a fluorinated nonionic surfactant, and a water-soluble inclusion compound.

Another aspect of the present invention provides a liquid composition including a fluorinated nonionic surfactant, and a water-soluble inclusion compound.

Another aspect of the present invention provides an image recording method including a step of applying a liquid composition to a recording medium, the liquid composition containing a pigment, a silicon-based nonionic surfactant, and a water-soluble inclusion compound, wherein a content (% by mass) of the nonionic surfactant is 0.5% by mass or more.

Another aspect of the present invention provides an image recording method including a step of applying a liquid composition to a recording medium, the liquid composition containing a dye, a silicon-based nonionic surfactant, and a water-soluble inclusion compound.

Another aspect of the present invention provides an image recording method including a step of applying a liquid composition to a recording medium, the liquid composition containing a silicon-based nonionic surfactant and a water-soluble inclusion compound, wherein the liquid composition includes no coloring material.

Another aspect of the present invention provides a liquid composition including a pigment, a silicon-based nonionic surfactant, and a water-soluble inclusion compound, wherein a content (% by mass) of the nonionic surfactant is 0.5% by mass or more.

Another aspect of the present invention provides a liquid composition including a dye, a silicon-based nonionic surfactant, and a water-soluble inclusion compound.

Another aspect of the present invention provides a liquid composition including a silicon-based nonionic surfactant, and a water-soluble inclusion compound, wherein the liquid composition contains no coloring material.

According to the present invention, a liquid composition capable of giving high quality and satisfactory images even by high-speed recording can be provided. According to the present invention, an image recording method using the liquid composition can also be provided.

Further features of the present invention will become apparent from the following description of exemplary embodiments with reference to the attached drawing.

### BRIEF DESCRIPTION OF THE DRAWINGS

FIGURE is a schematic view showing a structure of an ink jet recording apparatus used for image recording.

### DESCRIPTION OF THE EMBODIMENTS

Preferred embodiments of the present invention will now be described in detail in accordance with the accompanying drawing.

The inventors of the present invention have studied the ink disclosed in Japanese Patent Application Laid-Open No. 2014-077072 and have found that the ink is likely to cause nonuniformity in images obtained especially by high-speed recording and it is difficult to record high quality images.

An object of the present invention is thus to provide a liquid composition capable of giving high quality and satisfactory images even by high-speed recording. Another object of the present invention is to provide an image recording method using the liquid composition.

Embodiments of the present invention will now be described, but the present invention is not intended to be limited to the following embodiments. A technique for recording images with excellent quality on a liquid-component-non-absorbable or -poorly-absorbable recording medium (hereinafter also simply referred to as “non-absorbable recording medium or the like”) is to improve the wettability of a liquid composition such as an ink on a recording medium and to suppress repelling.

The inventors of the present invention have tried to reduce the surface tension of a liquid composition by adding a fluorinated surfactant or a silicon-based surfactant.

The fluorinated surfactant has a hydrophobic group (perfluoroalkyl group) formed by replacing hydrogen atoms of an alkyl chain with fluorine atoms. The hydrophobic group has a small intermolecular force between hydrophobic groups and has a small interaction with other substances. Thus, a small amount of the fluorinated surfactant can efficiently reduce the surface tension of a liquid composition.

The silicon-based surfactant has a hydrophobic organosiloxane structure. The organosiloxane structure has a smaller polarity compared with those of hydrocarbon chains of hydrocarbon-based surfactants commonly used in conventional inks and thus can efficiently reduce the surface tension of a liquid composition.

The inventors of the present invention have selectively used a nonionic surfactant having hydrophilic alkylene oxide chains among the fluorinated surfactants or the silicon-based surfactants. When an image is recorded, the water content of a liquid composition may be reduced due to the effect of wind at the time of conveyance of a recording medium, heat in an apparatus, or the like. As compared with an ionic group in the structure of an ionic surfactant, the alkylene oxide chain has higher compatibility with water and also has higher compatibility with solvents other than water contained in a liquid composition. On this account, if the water content of a liquid composition decreases on a recording medium, the nonionic surfactant is unlikely to precipitate.

The inventors have studied various image recording methods in order to satisfy both high-speed recording and image quality improvement by using a liquid composition such as an ink containing a fluorinated nonionic surfactant or a silicon-based nonionic surfactant, and consequently have revealed that various problems are caused.

The first problem is a reduction in the quality of images when an ink jet recording apparatus is used to perform continuous recording. It has been revealed that high quality images are recorded at the beginning, but image quality deteriorates as the number of records is increased. Detailed observation of the recorded images indicates that nonuniformity is caused in solid images.

The second problem is a reduction in the quality of images when a recording medium is heated and recorded. The inventors of the present invention have studied a technique of applying a liquid composition such as an ink to a heated recording medium in order to improve the fixability of images at the time of high-speed recording. The result has indicated that nonuniformity is likely to be caused in solid images when a non-absorbable recording medium or the like is used. The nonuniformity is caused not only when an ink jet recording apparatus is used but also when another technique such as roller coating is used to apply a liquid composition. From the above result, the inventors of the present invention have supposed that the nonuniformity in solid images is caused by an increase in temperature of a liquid composition.

It is known that in an ink jet recording apparatus, part of driving energy is lost as heat to increase the temperature of a recording head or an ink. The temperature increase is small at the beginning, but the temperature may be greatly increased during continuous printing at high speed. It has been ascertained that the temperature of a recording head is measured to be higher than room temperature when the image quality deteriorates.

The inventors of the present invention have supposed that the deterioration of images in association with increase of the temperature of a recording head or an ink is caused by a nonionic surfactant. The nonionic surfactant contained in a liquid composition has an alkylene oxide chain in the structure thereof. The alkylene oxide chain functions as a hydrophilic group that forms a hydrogen bond with a water molecule, and thus the nonionic surfactant is dissolved in a solvent. However, if the temperature of a liquid composition is increased, the hydrogen bond between the alkylene oxide chain and a water molecule is disconnected. As a result, the solubility of the alkylene oxide chain is lowered, and thus the nonionic surfactant is unlikely to be dissolved in water to cause cloudiness or separation into two layers. This is supposed to make the liquid composition have uneven physical properties.

The surfactant, which has a hydrophobic group and a hydrophilic group in a single molecule thereof, exerts surface activation performance. If the function of the hydrophilic group is reduced, the surface activation performance is accordingly reduced. This is thus supposed to reduce the surface tension of a liquid composition. The reduction of image quality by continuous recording is assumed to be caused by unstable ejection of a liquid composition having uneven physical properties due to an increase of the temperature.

The nonuniformity in solid images (coating nonuniformity) recorded on a heated recording medium is supposed to be caused by an increase in the surface tension of a liquid composition. As a result of intensive studies, the inventors of the present invention have found that by adding, together with a fluorinated nonionic surfactant or a silicon-based nonionic surfactant, a water-soluble inclusion compound to a liquid composition, high quality images can be continuously produced even by high-speed recording.

In order to suppress the change in physical properties of a liquid composition due to a temperature increase, the inventors of the present invention have considered that it is required to prevent the fluorinated nonionic surfactant or the silicon-based nonionic surfactant from losing the water-solubility thereof even when the temperature is increased. On the basis of such a concept, the inventors have studied the liquid composition such as an ink containing a water-soluble inclusion compound. The inclusion compound is a compound that forms a basket-shaped, tunnel-shaped, or layered molecular-scale space and can include another molecular species having a suitable shape and size in the formed space. The water-soluble inclusion compound is supposed to include a surfactant and to improve the hydrophilicity of the surfactant. The surfactant accordingly having higher hydrophilicity is still dissolved in water even when the temperature is increased, and thus cloudiness or two-layer separation is unlikely to be caused. In addition, the condition in which a hydrophobic group and a hydrophilic group are present in one molecule of a surfactant is maintained, and thus the surface activation performance is retained to suppress an increase in the surface tension of a liquid composition. As a result, the liquid composition has stable physical properties even when the temperature is increased, and it is supposed that high quality images can be produced even in high-speed recording.

Liquid Composition

A liquid composition (hereinafter also referred to as “first liquid composition”) of the present invention includes a pigment, a silicon-based nonionic surfactant, and a water-soluble inclusion compound. In the liquid composition, the content (% by mass) of the silicon-based nonionic surfactant is 0.5% by mass or more. A liquid composition of the present invention (hereinafter also referred to as “second liquid composition”) includes a dye, a silicon-based nonionic surfactant, and a water-soluble inclusion compound. A liquid composition of the present invention (hereinafter also referred to as “third liquid composition”) includes a silicon-based nonionic surfactant and a water-soluble inclusion compound, and the liquid composition includes no coloring material. A liquid composition of the present invention (hereinafter also referred to as “fourth liquid composition”) includes a fluorinated nonionic surfactant and a water-soluble inclusion compound. The liquid compositions of the present invention will be described in detail. In the following description, “(meth)acrylic acid” and “(meth)acrylate” mean “acrylic acid, methacrylic acid” and “acrylate, methacrylate”, respectively.

Silicon-Based Nonionic Surfactant

The silicon-based nonionic surfactant has a hydrophobic organosiloxane structure in the molecular structure thereof and has a hydrophilic alkylene oxide chain. Specific examples of the silicon-based nonionic surfactant include “BYK349”, “BYK333”, “BYK3455”, “BYK347”, “BYK348”, “BYK331”, and “BYK307” (manufactured by BYK-Chemie), which are trade names.

The content (% by mass) of the nonionic surfactant in each of the second and third liquid compositions is preferably 0.1% by mass or more to 90.0% by mass or less and more preferably 0.5% by mass or more to 90.0% by mass or less relative to the total amount of the liquid composition. If the content of the nonionic surfactant is less than 0.1% by mass, the surface tension of the liquid composition is not sufficiently reduced in some cases.

The content (% by mass) of the nonionic surfactant in the first liquid composition is 0.5% by mass or more to 90.0% by mass or less and preferably 1.0% by mass or more to 90.0% by mass or less relative to the total amount of the liquid composition. If the content of the nonionic surfactant is less than 0.5% by mass, the surface tension of the liquid composition is not sufficiently reduced. The first liquid composition contains a pigment, and some portion of the nonionic surfactant is supposed to be adsorbed to the particle surface of the hydrophobic pigment. The nonionic surfactant is thus required to be contained in a predetermined amount or more.

The silicon-based nonionic surfactant has a polyether chain as a side chain in the molecular structure thereof, and thus has a certain hydrophilicity, but is not required to be water-soluble. This is because the dispersion state of the surfactant widely varies depending on the type, the combination, or the ratio of solvents, water-soluble resins, particulate resins, and coloring materials commonly used in a liquid composition, for example. The nonionic surfactant thus may be any nonionic surfactant that is not separated or precipitated in the liquid composition and can maintain the dispersion state. In order to adjust the surface tension or the like, the liquid composition may further contain another surfactant in addition to the silicon-based nonionic surfactant.

Fluorinated Nonionic Surfactant

The fluorinated nonionic surfactant has a hydrophobic group formed by replacing hydrogen atoms of an alkyl chain with fluorine atoms in the molecular structure thereof and also has a hydrophilic alkylene oxide chain. Specific examples of the fluorinated nonionic surfactant include “Zonyl-FSO100”, “FSN100”, and “FS3100” (manufactured by Du Pont); and “MEGAFACE F444”, “F477”, and “F553” (manufactured by DIC), which are trade names.

The content (% by mass) of the nonionic surfactant in the fourth liquid composition is preferably 0.1% by mass or more to 90.0% by mass or less relative to the total amount of the liquid composition. If the content of the nonionic surfactant is less than 0.1% by mass, the surface tension of the liquid composition is not sufficiently reduced in some cases.

The fluorinated nonionic surfactant has a polyether chain as a side chain in the molecular structure thereof, and thus has a certain hydrophilicity, but is not required to be water-soluble. This is because the dispersion state of the surfactant widely varies depending on the type, the combination, or the ratio of solvents, water-soluble resins, particulate resins, and coloring materials commonly used in a liquid composition, for example. The nonionic surfactant thus may be any nonionic surfactant that is not separated or precipitated in the liquid composition and can maintain the dispersion state. In order to adjust the surface tension or the like, the liquid composition may further contain another surfactant in addition to the fluorinated nonionic surfactant.

Water-Soluble Inclusion Compound

The inclusion compound used in the liquid composition of the present invention is water-soluble and can be dissolved in water at a certain concentration or more. Specifically, the solubility of the inclusion compound in water at 25° C. is preferably 1% by mass or more. The inclusion compound may be such an inclusion compound that the solubility is increased by addition of a water-soluble organic solvent and the inclusion compound is accordingly dissolved in the liquid composition. The inclusion compound is preferably an inclusion compound that can interact with the fluorinated nonionic surfactant or the silicon-based nonionic surfactant.

The content (% by mass) of the inclusion compound in the liquid composition is preferably 0.1% by mass or more to 30% by mass or less relative to the total amount of the liquid composition. The content (% by mass) of the inclusion compound is preferably 8.0 times or less as much as the content (% by mass) of the nonionic surfactant in terms of mass ratio (the content of the inclusion compound/the content of the nonionic surfactant). If the mass ratio is more than 8.0, the content of the inclusion compound is excess, and a large number of inclusion compound molecules interact with a single molecule of a surfactant. Accordingly, the surfactant has excessively higher hydrophilicity to change the balance between a hydrophobic group and a hydrophilic group, and thus an intended surface tension reduction performance is not achieved in some cases.

Specific examples of the inclusion compound include cyclodextrins, crown ethers, cryptands, macrocyclic amines, calixarenes, thiacalixarenes, cyclophanes, proteins, DNAs, and RNAs. Specifically preferred is at least one of a cyclodextrin and a cyclodextrin derivative. The outside of the cyclic structure of cyclodextrins and cyclodextrin derivatives is hydrophilic, whereas the inside is hydrophobic. On this account, cyclodextrins and cyclodextrin derivatives can be stably present in the liquid composition. In addition, the inside of the cyclic structure interacts with the hydrophobic group of a surfactant, and thus the surfactant can obtain water-solubility.

Examples of the cyclodextrin include α-cyclodextrin, β-cyclodextrin, γ-cyclodextrin, and δ-cyclodextrin. Examples of the cyclodextrin derivative include compounds prepared by replacing hydroxy groups in the cyclodextrin structure with groups other than the hydroxy group, such as a methoxy group and an amino group. Additional examples are compounds prepared by replacing an ether bond present in the cyclodextrin structure with a bond (—NH—) derived from an imino group or a sulfide bond (—S—), for example.

Specific examples of the cyclodextrin derivative include methyl-β-cyclodextrin, hydroxypropyl-β-cyclodextrin, hydroxypropyl-γ-cyclodextrin, maltosyl-β-cyclodextrin, dimaltosyl-β-cyclodextrin, trimaltosyl-β-cyclodextrin, trimethyl-β-cyclodextrin, triacetyl-β-cyclodextrin, 3A-amino-3A-deoxy-(2AS,3AS)-α-cyclodextrin hydrate, 2,6-di-O-methyl-1-cyclodextrin, poly-β-cyclodextrin, mono-2-O-(p-toluenesulfonyl)-γ-cyclodextrin, and 5,10,15,20-tetrakis [4-(per-O-methyl-α-cyclodextrin-6-yloxy)phenyl]porphyrin.

Coloring Material

The first liquid composition of the present invention contains a pigment as the coloring material. The second liquid composition of the present invention contains a dye as the coloring material. The third liquid composition of the present invention contains no coloring material such as a pigment or a dye. The fourth liquid composition of the present invention may contain a coloring material. The coloring material may be any type, and a known dye or pigment can be used. The coloring materials may be used singly or in combination of two or more of them.

Pigment

As the pigment, pigments having color phases such as black, cyan, magenta, and yellow are usable. Specific examples of the pigment include carbon black and organic pigments. The content of the pigment in the first or fourth liquid composition is preferably 0.5% by mass or more to 15.0% by mass or less relative to the total mass of the first or fourth liquid composition. The pigments may be used singly or in combination of two or more of them.

As the pigment, any of self-dispersible pigments and resin-dispersed pigments can be used. The self-dispersible pigment is a pigment having a pigment particle surface to which a hydrophilic group is introduced to be dispersed in a medium. The resin-dispersed pigment is a pigment that is dispersed in a medium by using a resin as a dispersant. Examples of the resin-dispersed pigment include resin-dispersed pigments using a resin dispersant, microcapsule pigments prepared by covering the surface of pigment particles with a resin, and resin-bonded pigments prepared by chemically bonding an organic group containing a resin to the surface of pigment particles.

The self-dispersible pigment and the resin-dispersed pigment can be used in combination. The resin used as the dispersant (resin dispersant) preferably has a hydrophilic moiety and a hydrophobic moiety. Examples of the resin dispersant include acrylic resins prepared by polymerization of a monomer having a carboxy group, such as (meth)acrylic acid; and urethane resins prepared by polymerization of a diol having an anionic group, such as dimethylolpropionic acid.

The resin dispersant preferably has an acid value of 50 mg KOH/g or more to 550 mg KOH/g or less. The resin dispersant preferably has a weight average molecular weight (Mw) of 1,000 or more to 50,000 or less that is determined by gel permeation chromatography (GPC) in terms of polystyrene.

The content of the resin dispersant in the liquid composition is preferably 0.1% by mass or more to 10.0% by mass or less relative to the total mass of the liquid composition. The content (% by mass) of the resin dispersant is preferably 0.1 time or more to 5.0 times or less as much as the content (% by mass) of the pigment in terms of mass ratio (the content of the resin dispersant/the content of the pigment).

Dye

As the dye, dyes having color phases such as black, cyan, magenta, and yellow are usable. The content of the dye in the second or fourth liquid composition is preferably 1.0% by mass or more to 20.0% by mass or less relative to the total mass of the second or fourth liquid composition. Specific examples of the dye include acid dyes, direct dyes, basic dyes, and disperse dyes described in the COLOUR INDEX.

Water-Soluble Resin, Particulate Resin

The liquid composition of the present invention preferably contains at least one of a water-soluble resin and a particulate resin. The water-soluble resin is a resin that can be dissolved in water at a certain concentration or more. Specifically, the solubility of the water-soluble resin in water at 25° C. is preferably 1% by mass or more. The water-soluble resin may be such a water-soluble resin that the solubility is increased by addition of a water-soluble organic solvent and the water-soluble resin is accordingly dissolved in the liquid composition.

As the water-soluble resin, known water-soluble resins including naturally derived water-soluble resins and synthetic water-soluble resins can be used. The naturally derived water-soluble resin is exemplified by polysaccharides such as starch; and proteins such as glue and gelatin. Chemically modified resins of naturally derived water-soluble resins, such as hydroxyethyl cellulose can also be used.

The synthetic water-soluble resin is exemplified by polyacrylamide, polyvinylpyrrolidone, polyalkylene glycol, polyvinyl alcohol, and polyethyleneimine. Specifically preferred are resins prepared by copolymerization of a hydrophobic monomer and a hydrophilic monomer, such as styrene-acrylic acid copolymers. Such a resin is preferred because the water solubility can be controlled by changing the ratio of the hydrophobic monomer and the hydrophilic monomer or by changing the structure (for example, random, graft, and block copolymers).

The water-soluble resin preferably has a weight average molecular weight of 1,000 or more to 50,000 or less as determined by GPC in terms of polystyrene. The content of the water-soluble resin in the liquid composition is preferably 0.3% by mass or more to 25.0% by mass or less relative to the total mass of the liquid composition.

The particulate resin is a resin that can be dispersed and present in a solvent in the state of particles having a particle size. The particulate resin preferably has a 50% cumulative volume average particle diameter (Ds) of 10 nm or more, more preferably 10 nm or more to 1,000 nm or less, and even more preferably 100 nm or more to 500 nm or less. The D₅₀ of the particulate resin can be determined by the following procedure. First, a particulate resin is diluted 50 times (in terms of volume) with pure water to prepare a measurement sample. Next, the prepared measurement sample can be subjected to measurement with a dynamic light scattering type particle size analyzer (trade name “UPA-EX150”, manufactured by NIKKISO CO., LTD.) under the conditions of a Set-Zero of 30 s, a number of measurements of three times, a measurement time of 180 seconds, and a refractive index of 1.5, giving the D₅₀ of the particulate resin. The D₅₀ of the particulate resin in the particulate resin dispersion prepared in examples described later was also determined by this procedure.

The resin constituting the particulate resin preferably has a weight average molecular weight of 1,000 or more to 2,000,000 or less as determined by GPC in terms of polystyrene. The content of the particulate resin in the liquid composition is preferably 1.0% by mass or more to 50.0% by mass or less and more preferably 2.0% by mass or more to 40.0% by mass or less relative to the total mass of the liquid composition.

The particulate resin is exemplified by particles of a resin such as acrylic resins, vinyl acetate resins, ester resins, ethylene resins, urethane resins, synthetic rubbers, vinyl chloride resins, vinylidene chloride resins, and olefinic resins. Specifically preferred are particulate acrylic resins and particulate urethane resins.

The monomer used for preparing the resin constituting an acrylic particulate resin (acrylic resin) may be any monomer applicable to a polymerization method such as emulsion polymerization, suspension polymerization, and dispersion polymerization. Examples of the monomer usable for producing the particulate acrylic resin include α,β-unsaturated carboxylic acids such as (meth)acrylic acid, maleic acid, crotonic acid, angelic acid, itaconic acid, and fumaric acid and salts thereof; ester compounds of α,β-unsaturated carboxylic acids, such as ethyl (meth)acrylate, methyl (meth)acrylate, butyl (meth)acrylate, methoxyethyl (meth)acrylate, ethoxyethyl (meth)acrylate, diethylene glycol (meth)acrylate, triethylene glycol (meth)acrylate, tetraethylene glycol (meth)acrylate, polyethylene glycol (meth)acrylate, methoxydiethylene glycol (meth)acrylate, methoxytriethylene glycol (meth)acrylate, methoxytetraethylene glycol (meth)acrylate, methoxypolyethylene glycol (meth)acrylate, cyclohexyl (meth)acrylate, isobornyl (meth)acrylate, N,N-dimethylaminopropyl (meth)acrylate, monobutyl maleate, and dimethyl itaconate; alkyl amide compounds of α,β-unsaturated carboxylic acids, such as (meth)acrylamide, dimethyl(meth)acrylamide, N,N-dimethylethyl(meth)acrylamide, N,N-dimethylpropyl(meth)acrylamide, isopropyl(meth)acrylamide, diethyl(meth)acrylamide, (meth)acryloylmorpholine, maleic acid monoamide, and crotonic acid methylamide; α,β-ethylenically unsaturated compounds having an aryl group, such as styrene, α-methylstyrene, vinyl phenylacetate, benzyl (meth)acrylate, and 2-phenoxyethyl (meth)acrylate; and ester compounds of polyfunctional alcohols, such as ethylene glycol diacrylate and polypropylene glycol dimethacrylate.

The acrylic resin may be a homopolymer prepared by polymerization of a single monomer or a copolymer prepared by polymerization of two or more monomers. The copolymer may be a random copolymer or a block copolymer. Specifically preferred are copolymers prepared by polymerization of a hydrophilic monomer and a hydrophobic monomer. The hydrophilic monomer is exemplified by α,β-unsaturated carboxylic acids and salts thereof. The hydrophobic monomer is exemplified by ester compounds of α,β-unsaturated carboxylic acids and α,β-ethylenically unsaturated compounds having an aryl group.

The resin constituting the particulate urethane resin (urethane resin) is a resin prepared by reacting a polyisocyanate which is a compound having two or more isocyanate groups and a polyol compound which is a compound having two or more hydroxy groups. The urethane resin may be any urethane resin that is prepared by reacting a known polyisocyanate compound and a known polyol compound and can form a particulate resin satisfying the above conditions.

The structure of the particulate resin is exemplified by a single layer structure and a multi-layered structure such as a core-shell structure. Specifically, the particulate resin having a multi-layered structure is preferred, and the particulate resin having a core-shell structure is more preferred. The particulate resin having a core-shell structure can function in different ways between the function of the core part and the function of the shell part. If the particulate resin having such a core-shell structure is used, more functions can be imparted to the liquid composition than those when a particulate resin having a single layer structure is used.

Reactant

The third or fourth liquid composition of the present invention preferably further contains a reactant that increases the viscosity of an ink containing a coloring material when the reactant comes into contact with the ink. A two-liquid reaction system of applying an ink and a reaction liquid to a recording medium to record images has been studied. By the two-liquid reaction system, the reactant in the reaction liquid rapidly increases the viscosity of the ink and thus can effectively suppress blurring and bleeding. Hence, the two-liquid reaction system enables the recording of high quality images even on non-absorbable or poorly-absorbable recording media.

The reactant is a component that can destabilize the dispersion or dissolving state of a coloring material (pigment or dye) in an ink to increase the viscosity of the ink when the reactant comes into contact with the ink containing the coloring material. On this account, if the third or fourth liquid composition containing the reactant is used in a two-liquid reaction system, the viscosity of another liquid composition to come into contact and mix therewith can be increased.

As the reactant, at least one of polyvalent metal ions and organic acids is preferably used. The polyvalent metal ion may be any of divalent and higher-valent metal ions. Specific examples of the polyvalent metal ion include divalent metal ions such as Ca²⁺, Cu²⁺, Ni²⁺, Mg²⁺, Sr²⁺, Ba²⁺, and Zn²⁺; and trivalent metal ions such as Fe³⁺, Cr³⁺, Y³⁺, and Al³⁺. The polyvalent metal ion can be added to the third or fourth liquid composition in a salt (polyvalent metal salt) form such as hydroxides and chlorides, which can dissociate to generate ions. The polyvalent metal salt is preferably formed from at least one polyvalent metal ion selected from the group consisting of Ca²⁺, Cu²⁺, Ni²⁺, Mg²⁺, Zn²⁺, Ba²⁺, Al³⁺, Fe³⁺, Cr³⁺ and Y³⁺, and a negative ion.

The content of the polyvalent metal ion in the third or fourth liquid composition is preferably 3.0% by mass or more to 90.0% by mass or less and more preferably 5.0% by mass or more to 70.0% by mass or less relative to the total mass of the third or fourth liquid composition.

Specific examples of the organic acid include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, lactic acid, pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, oxysuccinic acid, and dioxysuccinic acid.

The content of the organic acid in the third or fourth liquid composition is preferably 3.0% by mass or more to 90.0% by mass or less and more preferably 5.0% by mass or more to 70.0% by mass or less relative to the total mass of the third or fourth liquid composition.

Aqueous Medium

The liquid composition can typically contain an aqueous medium. As the aqueous medium, water or a mixed solvent of water and a water-soluble organic solvent can be used. The content of the water-soluble organic solvent in the liquid composition is preferably 3.0% by mass or more to 50.0% by mass or less relative to the total mass of the aqueous medium. Examples of the water-soluble organic solvent include alcohols, glycols, alkylene glycols having an alkylene group with 2 to 6 carbon atoms, polyethylene glycols, nitrogen-containing compounds, and sulfur-containing compounds. These water-soluble organic solvents can be used singly or in combination of two or more of them. The water is preferably deionized water (ion-exchanged water). The content of the water in the liquid composition is preferably 5.0% by mass or more to 95.0% by mass or less relative to the total mass of the aqueous medium.

The content of the aqueous medium in the liquid composition is preferably 8% by mass or more to 95% by mass or less and more preferably 35% by mass or more to 90% by mass or less relative to the total mass of the liquid composition.

Other Components

The liquid composition can contain various components in addition to the above components, as necessary. The liquid composition may contain water-soluble organic compounds that are solid at normal temperature, including polyhydric alcohols such as trimethylolpropane and trimethylolethane; and urea and urea derivatives such as ethylene urea. The liquid composition may further contain various components such as surfactants other than the fluorinated nonionic surfactant or the silicon-based nonionic surfactant, pH adjusters, anticorrosives, antiseptic agents, antifungal agents, antioxidants, reduction inhibitors, evaporation accelerators, and chelating agents, as necessary.

Image Recording Method

An image recording method (hereinafter also referred to as “first image recording method”) of the present invention includes a step of ejecting the above liquid composition from an ink jet recording head to apply the liquid composition to a recording medium. An image recording method (hereinafter also referred to as “second image recording method”) of the present invention includes a step of applying the above liquid composition to a liquid-component-non-absorbable or -poorly-absorbable recording medium (non-absorbable recording medium or the like).

Recording Head

In the first image recording method, the liquid composition is ejected from an ink jet recording head to be applied to a recording medium. In the second image recording method, the liquid composition is preferably ejected from an ink jet recording head to be applied to a recording medium. The recording head system includes (i) a system that causes film boiling of an ink by an electrothermal converter to form bubbles and ejects the ink, (ii) a system that ejects an ink by an electromechanical converter, and (iii) a system that ejects an ink by using static electricity, for example. Specifically, the recording head having the system (i) of ejecting an ink by an electrothermal converter is preferably used because such a recording head enables high-density printing at high speed.

The recording head includes what is called a shuttle type ink jet head which is scanned in a direction substantially orthogonal to the moving direction of a recording medium for recording and what is called a line type recording head which has ink ejection orifices arranged in a linear manner substantially orthogonal to the moving direction of a recording medium, for example. The recording method of the present invention can use any of the recording heads.

In the image recording method of the present invention, the liquid composition is preferably ejected from a heated recording head. Specifically, the liquid composition is preferably ejected from a recording head having a temperature of more than 35° C. To heat a recording head, a method of applying, to a heater of a nozzle in the recording head, an electric pulse at such an intensity as not to eject an ink to generate heat can be used, for example. Alternatively, a recording head can also be heated by a heater attached to the outside of the recording head to generate heat. The temperature of the recording head can be measured by using a thermocouple thermometer or a noncontact infrared thermometer. In the image recording method of the present invention, the temperature of a recording head at a position through which an ink is ejected is preferably measured because the temperature of the liquid composition affects images to be recorded.

Recording Medium

The recording medium used in the first image recording method is exemplified by paper exclusively for ink jet recording having an ink receiving layer and plain paper, printing paper, fabric, plastic, and film that are used for common printing. The recording medium may be cut into an intended size in advance. The recording medium may also be a rolled sheet before image recording and may be cut into an intended size after image recording.

In the second image recording method, the liquid composition is applied to a liquid-component-non-absorbable or -poorly-absorbable recording medium (non-absorbable recording medium or the like). In the first image recording method, the liquid composition is preferably applied to a non-absorbable recording medium or the like. This is because the liquid composition used in the image recording method of the present invention has a formulation effective in recording of images on a recording medium that does not absorb or hardly absorbs the liquid component in the liquid composition.

The non-absorbable recording medium is exemplified by synthetic films composed of polymer compounds such as polyethylene, transparent polyethylene terephthalate, polypropylene, and vinyl chloride; papers coated with such a polymer compound; glass; metal: and ceramics. The poorly-absorbable recording medium is exemplified by print papers such as art paper, high-quality coated paper, medium-quality coated paper, high-quality lightweight coated paper, medium-quality lightweight coated paper, fine coated paper, and cast-coated paper.

The coating amount of the coating layer of the art paper is about 40 g/m² on each side. The coating amount of each coating layer of the high-quality coated paper and the medium-quality coated paper is about 20 g/m² on each side. The coating amount of each coating layer of the high-quality lightweight coated paper and the medium-quality lightweight coated paper is about 15 g/m on each side. The coating amount of the coating layer of the fine coated print paper is 12 g/m² or less on each side.

Specific examples of the high-quality coated paper include trade name, “U-LITE” (manufactured by NIPPON PAPER INDUSTRIES). Specific examples of the art paper include TOKUBISHI ART (manufactured by Mitsubishi Paper Mills) and Satin Kinfuji (manufactured by Oji Paper Co., Ltd.), which are trade names. Specific examples of the coated paper include OK Top Coat (manufactured by Oji Paper Co., Ltd.), Aurora Coat (manufactured by NIPPON PAPER INDUSTRIES), and Recycle Coat T-6 (manufactured by NIPPON PAPER INDUSTRIES), which are trade names. Specific examples of the lightweight coated paper include U-LITE (manufactured by NIPPON PAPER INDUSTRIES), New V Matt (manufactured by Mitsubishi Paper Mills), New Age (manufactured by Oji Paper Co., Ltd.), Recycle Matt T-6 (manufactured by NIPPON PAPER INDUSTRIES), and Pism (manufactured by NIPPON PAPER INDUSTRIES), which are trade names. Specific examples of the fine coated print paper include Aurora L (manufactured by NIPPON PAPER INDUSTRIES) and Kinmari Hi-L (manufactured by Hokuetsu Paper Mills), which are trade names. Specific examples of the cast-coated paper include Mirror Coat G (manufactured by Oji Paper Co., Ltd.), SA Kinfuji Plus (manufactured by Oji Paper Co., Ltd.), and High McKinley Art (manufactured by Gojo Paper), which are trade names.

Intermediate Transfer Member

In the image recording method of the present invention, an intermediate transfer member is also preferably used as the recording medium. In other words, images can be recorded by a transfer system in the image recording method of the present invention. The transfer system is one of the image recording methods (printing methods). Specifically, the transfer system includes an intermediate image recording step of applying a liquid composition to an intermediate transfer member as the recording medium to record an intermediate image and a transfer step of pressure-bonding the intermediate transfer member to an object to be printed to transfer the intermediate image to the object to be printed.

The intermediate transfer member is required to have such characteristics that an intermediate image can be recorded and that the recorded intermediate image can be transferred to an object to be printed (recording medium). The intermediate transfer member includes a support member for transmitting the force applied by handling and a surface layer member placed on the surface of the support member for recording an intermediate image, for example. The support member and the surface layer member may be formed from an integrated member, or each may be formed from a plurality of independent members.

The surface layer member is preferably formed of a water repellent material. This is because an intermediate image recorded on the intermediate transfer member is allowed to be transferred to an object to be printed, such as paper. In terms of durability and transferability to an object to be printed, the water repellent material is preferably silicone rubber, fluororubber, fluorosilicone rubber, phenylsilicone rubber, and siloxane compounds such as a condensate prepared from a hydrolyzable organic silicon compound as a raw material. The surface layer member is also preferably a laminate of a plurality of materials. Specifically preferred is a laminate prepared by coating a polyurethane belt with a thin silicone rubber layer, for example. Between the surface layer member and the support member, various adhesives or a double-sided adhesive tape may be interposed in order to fix and hold these members.

Heating of Recording Medium

In the image recording method of the present invention, the liquid composition is preferably applied to a heated recording medium. Specifically, the liquid composition is preferably applied to a recording medium having a temperature of 35° C. or more. This enables the temperature control of the liquid composition that is applied to the recording medium. The recording medium can be heated by heat generated from a heater attached to a conveyer stage on which the recording medium is placed, for example. Alternatively, the recording medium can be heated by applying heat generated from a heater arranged above a conveyer stage on which the recording medium is placed.

The temperature of the recording medium can be measured by using a thermocouple thermometer or a noncontact infrared thermometer. In the image recording method of the present invention, the temperature of the recording medium at a position with which an ink comes into contact (surface portion) is preferably measured because the temperature of the liquid composition affects images to be recorded.

### Examples

The present invention will next be described in further detail with reference to examples and comparative examples, but the invention is not intended to be limited to the following examples without departing from the scope of the invention. The component amounts with “part(s)” or “%” are based on mass unless otherwise noted.

Preparation of Coloring Material

Dye

As a black dye, C.I. Food Black-2 was prepared.

Self-Dispersible Pigment

As a black self-dispersible pigment, a commercially available pigment dispersion liquid (trade name “Cab-O-JET200”, manufactured by Cabot) was prepared.

Resin-Dispersed Pigment

First, 10 parts of carbon black, 15 parts of an aqueous water-soluble resin solution as a pigment dispersant, and 75 parts of pure water were mixed, and the mixture was placed in a batch type vertical sand mill (manufactured by Aimex). As the carbon black, trade name “Monarch 1100” (manufactured by Cabot) was used. As the aqueous water-soluble resin solution, a solution prepared by neutralizing an aqueous solution (resin content 20.0%) of a styrene-ethyl acrylate-acrylic acid copolymer (acid value 150 mg KOH/g, weight average molecular weight 8,000) with an aqueous potassium hydroxide solution was used. In the mill, 200 parts of 0.3-mm zirconia beads were placed, and the mixture was subjected to dispersion treatment for 5 hours while being cooled with water, giving a dispersion liquid. The obtained dispersion liquid was centrifuged to remove coarse particles, giving a black resin-dispersed pigment.

Preparation of Particulate Resin Dispersion

First, 18 parts of ethyl methacrylate, 2 parts of 2,2′-azobis-(2-methylbutyronitrile), and 2 parts of n-hexadecane were mixed, and the whole was stirred for 0.5 hour to give a mixture. The obtained mixture was added dropwise to 78 parts of a 6% aqueous solution of polyoxyethylene cetyl ether (trade name “NIKKOL BC-15”, manufactured by Nikko Chemicals), and the resulting mixture was stirred for 0.5 hour and then sonicated by using a sonicator for 3 hours. Under a nitrogen atmosphere, the mixture was polymerized at 80° C. for 4 hours. The reaction mixture was cooled to room temperature and then filtered, giving a particulate resin dispersion having a content of particulate resin 1 of 40.0%. The resin constituting the particulate resin 1 had a weight average molecular weight of 250,000, and the particulate resin 1 had an average particle diameter (D) of 200 nm.

Preparation of Water-Soluble Resin

The anionic water-soluble resins (water-soluble resins 1 to 3) shown below were prepared.

Water-Soluble Resin 1

A benzyl methacrylate-methyl acrylate-acrylic acid copolymer (acid value: 120 mg KOH/g, weight average molecular weight: 9,000, neutralizer: potassium hydroxide)

Water-Soluble Resin 2

A styrene-butyl acrylate-acrylic acid copolymer (acid value: 90 mg KOH/g, weight average molecular weight: 7,000, neutralizer: potassium hydroxide)

Water-Soluble Resin 3

A 9-anthrylmethyl methacrylate-methyl methacrylate-methacrylic acid copolymer (acid value: 120 mg KOH/g, weight average molecular weight: 11,000, neutralizer: potassium hydroxide)

Preparation of Liquid Composition

In accordance with the formulations shown in Tables 1-1 and 1-2 and Tables 2-1 to 2-4, the respective components were mixed and thoroughly stirred, and the mixtures were subjected to pressure filtration through a microfilter with a pore size of 3.0 μm (manufactured by Fujifilm Corporation), giving liquid compositions. Each remainder of water (ion-exchanged water) in Tables 1-1 and 1-2 and Tables 2-1 to 2-4 is such an amount that the total amount of all the components constituting the corresponding liquid composition is 100%.

Each content (%) of the resin-dispersed pigments of the contents (%) of the coloring materials in Table 1-1 and Tables 2-1 and 2-2 means the content of the pigment itself and does not include the amount of the resin dispersant (water-soluble resin). The content (%) of the particulate resin dispersion means the content of the particulate resin itself.

TABLE 1-1

| | | | Nonionic | | | | Particulate | | Water- | | | |
|---|---|---|---|---|---|---|---|---|---|---|---|---|
| Liquid | Inclusion compound | | surfactant | | Coloring material | | resin dispersion | | soluble resin | | Glycerol | |
| compo- | | Content | | Content | | Content | | Content | | Content | Content | |
| sition | Type | (%) | Type | (%) | Type | (%) | Type | (%) | Type | (%) | (%) | Water |
| 1A | Methyl-β- | 0.5 | FSO | 2 | Self-dispersed | 4 | Particulate | 5 | — | — | 10 | Remainder |
| | cyclodextrin | | 100 | | pigment | | resin 1 | | | | | |
| 2A | Methyl-β- | 1 | FSO | 2 | Resin-dispersed | 4 | Particulate | 5 | — | — | 10 | Remainder |
| | cyclodextrin | | 100 | | pigment | | resin 1 | | | | | |
| 3A | Methyl-β- | 0.4 | FSO | 0.2 | Dye | 4 | Particulate | 5 | — | — | 10 | Remainder |
| | cyclodextrin | | 100 | | | | resin 1 | | | | | |
| 4A | Methyl-β- | 1 | FSO | 1 | — | — | Particulate | 10 | — | — | 10 | Remainder |
| | cyclodextrin | | 100 | | | | resin 1 | | | | | |
| 5A | Methyl-β- | 0.5 | FSO | 0.5 | Self-dispersed | 4 | — | — | Water- | 10 | 10 | Remainder |
| | cyclodextrin | | 100 | | pigment | | | | soluble | | | |
| | | | | | | | | | resin 1 | | | |
| 6A | Methyl-β- | 3 | FSO | 12 | Resin-dispersed | 4 | — | — | Water- | 5 | 10 | Remainder |
| | cyclodextrin | | 3100 | | pigment | | | | soluble | | | |
| | | | | | | | | | resin 2 | | | |
| 7A | Methyl-β- | 3 | F444 | 3 | Resin-dispersed | 4 | — | — | Water- | 5 | 10 | Remainder |
| | cyclodextrin | | | | pigment | | | | soluble | | | |
| | | | | | | | | | resin 3 | | | |
| 8A | α-cyclodextrin | 1.5 | FSO | 3 | Resin-dispersed | 4 | — | — | — | — | 10 | Remainder |
| | | | 100 | | pigment | | | | | | | |
| 9A | β-cyclodextrin | 0.2 | FSO | 0.5 | Resin-dispersed | 4 | — | — | — | — | 10 | Remainder |
| | | | 100 | | pigment | | | | | | | |
| 10A | γ-cyclodextrin | 1.5 | FSO | 3 | Resin-dispersed | 4 | — | — | — | — | 10 | Remainder |
| | | | 100 | | pigment | | | | | | | |
| 11A | Hydroxypropyl-β- | 24 | FSO | 3 | Resin-dispersed | 4 | — | — | — | — | 10 | Remainder |
| | cyclodextrin | | 100 | | pigment | | | | | | | |
| 12A | Maltosyl-β- | 15 | FSO | 3 | Resin-dispersed | 4 | — | — | — | — | 10 | Remainder |
| | cyclodextrin | | 100 | | pigment | | | | | | | |
| 13A | 4- | 1.5 | FSO | 3 | Resin-dispersed | 4 | — | — | — | — | 10 | Remainder |
| | Sulfocalix[6]arene | | 100 | | pigment | | | | | | | |
| 14A | Bovine | 1.5 | FSO | 3 | Resin-dispersed | 4 | — | — | — | — | 10 | Remainder |
| | serum albumin | | 100 | | pigment | | | | | | | |
| 15A | Methyl-β- | 4 | FSO | 0.5 | Resin-dispersed | 4 | — | — | — | — | 10 | Remainder |
| | cyclodextrin | | 100 | | pigment | | | | | | | |
| 16A | Hydroxypropyl-β- | 30 | FSO | 3 | Resin-dispersed | 4 | — | — | — | — | 10 | Remainder |
| | cyclodextrin | | 100 | | pigment | | | | | | | |
| 17A | Methyl-β- | 0.75 | FSO | 3 | Resin-dispersed | 4 | — | — | — | — | 10 | Remainder |
| | cyclodextrin | | 100 | | pigment | | | | | | | |
| 18A | — | — | FSO | 3 | Resin-dispersed | 4 | — | — | — | — | 10 | Remainder |
| | | | 100 | | pigment | | | | | | | |
| 19A | Calix[6]arene | 1.5 | FSO | 3 | Resin-dispersed | 4 | — | — | — | — | 10 | Remainder |
| | | | 100 | | pigment | | | | | | | |

TABLE 1-2

| | | | Nonionic | | | | | | |
|---|---|---|---|---|---|---|---|---|---|
| | Inclusion compound | | surfactant | | Reactant | | KOH | Glycerol | |
| Liquid | | Content | | Content | | Content | Content | Content | |
| composition | Type | (%) | Type | (%) | Type | (%) | (%) | (%) | Water |
| 1B | Methyl-β-cyclodextrin | 7 | FSO | 10 | Glutaric acid | 30 | 5 | 10 | Remainder |
| | | | 100 | | | | | | |
| 2B | Methyl-β-cyclodextrin | 15 | FSO | 30 | Citric acid | 30 | 5 | 10 | Remainder |
| | | | 100 | | | | | | |
| 3B | Methyl-β-cyclodextrin | 7 | FSO | 10 | Malic acid | 30 | 5 | 10 | Remainder |
| | | | 100 | | | | | | |
| 4B | Methyl-β-cyclodextrin | 0.5 | FSO | 2 | Malonic acid | 30 | 5 | 10 | Remainder |
| | | | 100 | | | | | | |
| 5B | Methyl-β-cyclodextrin | 7 | FSO | 10 | Ca nitrate | 3 | — | 10 | Remainder |
| | | | 100 | | | | | | |
| 6B | Methyl-β-cyclodextrin | 7 | FSO | 10 | Ca chloride | 3 | — | 10 | Remainder |
| | | | 100 | | | | | | |
| 7B | Methyl-β-cyclodextrin | 6 | FSO | 10 | Glutaric acid | 30 | 5 | 10 | Remainder |
| | | | 3100 | | | | | | |
| 8B | Methyl-β-cyclodextrin | 6 | F444 | 10 | Glutaric acid | 30 | 5 | 10 | Remainder |
| 9B | α-cyclodextrin | 1.5 | FSO | 10 | Glutaric acid | 30 | 5 | 10 | Remainder |
| | | | 100 | | | | | | |
| 10B | β-cyclodextrin | 1 | FSO | 10 | Glutaric acid | 30 | 5 | 10 | Remainder |
| | | | 100 | | | | | | |
| 11B | γ-cyclodextrin | 1.5 | FSO | 10 | Glutaric acid | 30 | 5 | 10 | Remainder |
| | | | 100 | | | | | | |
| 12B | Hydroxypropyl-β-cyclodextrin | 24 | FSO | 10 | Glutaric acid | 30 | 5 | 10 | Remainder |
| | | | 100 | | | | | | |
| 13B | Maltosyl-β-cyclodextrin | 15 | FSO | 10 | Glutaric acid | 30 | 5 | 10 | Remainder |
| | | | 100 | | | | | | |
| 14B | 4-Sulfocalix[6]arene | 1.5 | FSO | 10 | Ca nitrate | 3 | — | 10 | Remainder |
| | | | 100 | | | | | | |
| 15B | Bovine serum albumin | 1.5 | FSO | 10 | Ca chloride | 3 | — | 10 | Remainder |
| | | | 100 | | | | | | |
| 16B | Methyl-β-cyclodextrin | 4 | FSO | 0.5 | Glutaric acid | 30 | 5 | 10 | Remainder |
| | | | 100 | | | | | | |
| 17B | Hydroxypropyl-β-cyclodextrin | 30 | FSO | 3 | Glutaric acid | 30 | 5 | 10 | Remainder |
| | | | 100 | | | | | | |
| 18B | Methyl-β-cyclodextrin | 0.75 | FSO | 3 | Glutaric acid | 30 | 5 | 10 | Remainder |
| | | | 100 | | | | | | |
| 19B | — | — | FSO | 3 | Glutaric acid | 30 | 5 | 10 | Remainder |
| | | | 100 | | | | | | |
| 20B | Calix[6]arene | 1.5 | FSO | 3 | Glutaric acid | 30 | 5 | 10 | Remainder |
| | | | 100 | | | | | | |

In the respective liquid compositions, the mass ratios (A/B) of the content A (%) of the inclusion compound to the content B (%) of the fluorinated nonionic surfactant are shown in Tables 1-3 and 1-4. In the respective liquid compositions, the mass ratios (A/C) of the content A (%) of the inclusion compound to the content C (%) of the silicon-based nonionic surfactant are shown in Tables 2-1 to 2-4.

TABLE 1-3

| | A/B |
|---|---|
| Liquid composition 1A | 0.25 |
| Liquid composition 2A | 0.5 |
| Liquid composition 3A | 2 |
| Liquid composition 4A | 1 |
| Liquid composition 5A | 1 |
| Liquid composition 6A | 0.25 |
| Liquid composition 7A | 1 |
| Liquid composition 8A | 0.5 |
| Liquid composition 9A | 0.4 |
| Liquid composition 10A | 0.5 |
| Liquid composition 11A | 8 |
| Liquid composition 12A | 5 |
| Liquid composition 13A | 0.5 |
| Liquid composition 14A | 0.5 |
| Liquid composition 15A | 8 |
| Liquid composition 16A | 10 |
| Liquid composition 17A | 0.25 |
| Liquid composition 18A | 0 |
| Liquid composition 19A | 0.5 |

TABLE 1-4

| | A/B |
|---|---|
| Liquid composition 1B | 0.7 |
| Liquid composition 2B | 0.5 |
| Liquid composition 3B | 0.7 |
| Liquid composition 4B | 0.25 |
| Liquid composition 5B | 0.7 |
| Liquid composition 6B | 0.7 |
| Liquid composition 7B | 0.6 |
| Liquid composition 8B | 0.6 |
| Liquid composition 9B | 0.15 |
| Liquid composition 10B | 0.1 |
| Liquid composition 11B | 0.15 |
| Liquid composition 12B | 2.4 |
| Liquid composition 13B | 1.5 |
| Liquid composition 14B | 0.15 |
| Liquid composition 15B | 0.15 |
| Liquid composition 16B | 8 |
| Liquid composition 17B | 10 |
| Liquid composition 18B | 0.25 |
| Liquid composition 19B | 0 |
| Liquid composition 20B | 0.5 |

TABLE 2-1

| | | | Nonionic | | Coloring | | | | | | |
|---|---|---|---|---|---|---|---|---|---|---|---|
| | Inclusion compound | | surfactant | | material | | Particulate resin dispersion | | Glycerol | | |
| Liquid | | Content | | Content | | Content | | Content | Content | | |
| composition | Type | A (%) | Type | C (%) | Type | (%) | Type | (%) | (%) | Water | A/C |
| 1C | Methyl-β-cyclodextrin | 3 | BYK | 3 | Self- | 4 | — | — | 10 | Remainder | 1 |
| | | | 347 | | dispersible | | | | | | |
| | | | | | pigment | | | | | | |
| 2C | Methyl-β-cyclodextrin | 3 | BYK | 3 | Resin- | 4 | — | — | 10 | Remainder | 1 |
| | | | 347 | | dispersed | | | | | | |
| | | | | | pigment | | | | | | |
| 3C | Methyl-β-cyclodextrin | 3 | BYK | 12 | Resin- | 4 | Particulate | 5 | 10 | Remainder | 0.25 |
| | | | 333 | | dispersed | | resin 1 | | | | |
| | | | | | pigment | | | | | | |
| 4C | Methyl-β-cyclodextrin | 3 | BYK | 3 | Resin- | 4 | — | — | 10 | Remainder | 1 |
| | | | 3455 | | dispersed | | | | | | |
| | | | | | pigment | | | | | | |
| 5C | Methyl-β-cyclodextrin | 0.2 | BYK | 0.5 | Resin- | 4 | — | — | 10 | Remainder | 0.4 |
| | | | 348 | | dispersed | | | | | | |
| | | | | | pigment | | | | | | |
| 6C | Methyl-β-cyclodextrin | 7.5 | BYK | 15 | Resin- | 4 | — | — | 10 | Remainder | 0.5 |
| | | | 349 | | dispersed | | | | | | |
| | | | | | pigment | | | | | | |
| 7C | Methyl-β-cyclodextrin | 9 | BYK | 3 | Resin- | 4 | — | — | 10 | Remainder | 3 |
| | | | 331 | | dispersed | | | | | | |
| | | | | | pigment | | | | | | |
| 8C | α-cyclodextrin | 1.5 | BYK | 3 | Resin- | 4 | — | — | 10 | Remainder | 0.5 |
| | | | 347 | | dispersed | | | | | | |
| | | | | | pigment | | | | | | |
| 9C | β-cyclodextrin | 0.5 | BYK | 3 | Resin- | 4 | — | — | 10 | Remainder | 0.17 |
| | | | 347 | | dispersed | | | | | | |
| | | | | | pigment | | | | | | |
| 10C | γ-cyclodextrin | 1.5 | BYK | 3 | Resin- | 4 | — | — | 10 | Remainder | 0.5 |
| | | | 347 | | dispersed | | | | | | |
| | | | | | pigment | | | | | | |
| 11C | Hydroxypropyl-β- | 30 | BYK | 3 | Resin- | 4 | — | — | 10 | Remainder | 6 |
| | cyclodextrin | | 347 | | dispersed | | | | | | |
| | | | | | pigment | | | | | | |
| 12C | Maltosyl-β-cyclodextrin | 15 | BYK | 3 | Resin- | 4 | — | — | 10 | Remainder | 5 |
| | | | 347 | | dispersed | | | | | | |
| | | | | | pigment | | | | | | |
| 13C | 4-Sulfocalix[6]arene | 1.5 | BYK | 3 | Resin- | 4 | — | — | 10 | Remainder | 0.5 |
| | | | 347 | | dispersed | | | | | | |
| | | | | | pigment | | | | | | |
| 14C | Bovine serum albumin | 1.5 | BYK | 3 | Resin- | 4 | — | — | 10 | Remainder | 0.5 |
| | | | 347 | | dispersed | | | | | | |
| | | | | | pigment | | | | | | |
| 15C | Methyl-β-cyclodextrin | 4 | BYK | 0.5 | Resin- | 4 | — | — | 10 | Remainder | 8 |
| | | | 347 | | dispersed | | | | | | |
| | | | | | pigment | | | | | | |
| 16C | Methyl-β-cyclodextrin | 5 | BYK | 0.5 | Resin- | 4 | — | — | 10 | Remainder | 10 |
| | | | 347 | | dispersed | | | | | | |
| | | | | | pigment | | | | | | |
| 17C | Methyl-β-cyclodextrin | 2 | BYK | 0.3 | Resin- | 3 | — | — | 10 | Remainder | 6.67 |
| | | | 347 | | dispersed | | | | | | |
| | | | | | pigment | | | | | | |
| 18C | — | — | BYK | 3 | Resin- | 4 | — | — | 10 | Remainder | 0 |
| | | | 347 | | dispersed | | | | | | |
| | | | | | pigment | | | | | | |
| 19C | Calix[6]arene | 1.5 | BYK | 3 | Resin- | 4 | — | — | 10 | Remainder | 0.5 |
| | | | 347 | | dispersed | | | | | | |
| | | | | | pigment | | | | | | |

TABLE 2-2

| | | | Nonionic | | | | | | | | |
|---|---|---|---|---|---|---|---|---|---|---|---|
| | Inclusion compound | | surfactant | | Coloring material | | Particulate resin dispersion | | Glycerol | | |
| Liquid | | Content | | Content | | Content | | Content | Content | | |
| composition | Type | A (%) | Type | C (%) | Type | (%) | Type | (%) | (%) | Water | A/C |
| 1D | Methyl-β-cyclodextrin | 3 | BYK | 3 | Dye | 4 | — | — | 10 | Remainder | 1 |
| | | | 347 | | | | | | | | |
| 2D | Methyl-β-cyclodextrin | 3 | BYK | 12 | Dye | 4 | — | — | 10 | Remainder | 0.25 |
| | | | 333 | | | | | | | | |
| 3D | Methyl-β-cyclodextrin | 3 | BYK | 3 | Dye | 4 | Particulate | 5 | 10 | Remainder | 1 |
| | | | 3455 | | | | resin 1 | | | | |
| 4D | Methyl-β-cyclodextrin | 3 | BYK | 3 | Dye | 4 | — | — | 10 | Remainder | 1 |
| | | | 348 | | | | | | | | |
| 5D | Methyl-β-cyclodextrin | 10 | BYK | 15 | Dye | 4 | — | — | 10 | Remainder | 0.67 |
| | | | 349 | | | | | | | | |
| 6D | Methyl-β-cyclodextrin | 3 | BYK | 9 | Dye | 4 | — | — | 10 | Remainder | 0.33 |
| | | | 331 | | | | | | | | |
| 7D | α-cyclodextrin | 1.5 | BYK | 3 | Dye | 4 | — | — | 10 | Remainder | 0.5 |
| | | | 347 | | | | | | | | |
| 8D | β-cyclodextrin | 0.2 | BYK | 0.5 | Dye | 4 | — | — | 10 | Remainder | 0.4 |
| | | | 347 | | | | | | | | |
| 9D | γ-cyclodextrin | 1.5 | BYK | 0.3 | Dye | 4 | — | — | 10 | Remainder | 5 |
| | | | 347 | | | | | | | | |
| 10D | Hydroxypropyl-β- | 30 | BYK | 5 | Dye | 4 | — | — | 10 | Remainder | 6 |
| | cyclodextrin | | 347 | | | | | | | | |
| 11D | Maltosyl-β-cyclodextrin | 15 | BYK | 3 | Dye | 4 | — | — | 10 | Remainder | 5 |
| | | | 347 | | | | | | | | |
| 12D | 4-Sulfocalix[6]arene | 1.5 | BYK | 3 | Dye | 4 | — | — | 10 | Remainder | 0.5 |
| | | | 347 | | | | | | | | |
| 13D | Bovine serum albumin | 1.5 | BYK | 3 | Dye | 4 | — | — | 10 | Remainder | 0.5 |
| | | | 347 | | | | | | | | |
| 14D | Methyl-β-cyclodextrin | 4 | BYK | 0.5 | Dye | 4 | — | — | 10 | Remainder | 8 |
| | | | 347 | | | | | | | | |
| 15D | Methyl-β-cyclodextrin | 5 | BYK | 0.5 | Dye | 4 | — | — | 10 | Remainder | 10 |
| | | | 347 | | | | | | | | |
| 16D | — | — | BYK | 3 | Dye | 4 | — | — | 10 | Remainder | 0 |
| | | | 347 | | | | | | | | |
| 17D | Calix[6]arene | 1.5 | BYK | 3 | Dye | 4 | — | — | 10 | Remainder | 0.5 |
| | | | 347 | | | | | | | | |

TABLE 2-3

| | | | Nonionic | | | | | | | | |
|---|---|---|---|---|---|---|---|---|---|---|---|
| | Inclusion compound | | surfactant | | Coloring material | | Particulate resin dispersion | | Glycerol | | |
| Liquid | | Content | | Content | | Content | | Content | Content | | |
| composition | Type | A (%) | Type | C (%) | Type | (%) | Type | (%) | (%) | Water | A/C |
| 1E | Methyl-β-cyclodextrin | 3 | BYK | 3 | — | — | Particulate | 5 | 10 | Remainder | 1 |
| | | | 347 | | | | resin 1 | | | | |
| 2E | Methyl-β-cyclodextrin | 3 | BYK | 3 | Water-soluble | 5 | Particulate | 5 | 10 | Remainder | 1 |
| | | | 347 | | resin 1 | | resin 1 | | | | |
| 3E | Methyl-β-cyclodextrin | 3 | BYK | 3 | Water-soluble | 5 | — | — | 10 | Remainder | 1 |
| | | | 347 | | resin 1 | | | | | | |
| 4E | Methyl-β-cyclodextrin | 3 | BYK | 12 | Water-soluble | 5 | — | — | 10 | Remainder | 0.25 |
| | | | 333 | | resin 1 | | | | | | |
| 5E | Methyl-β-cyclodextrin | 0.6 | BYK | 0.3 | Water-soluble | 5 | — | — | 10 | Remainder | 2 |
| | | | 3455 | | resin 1 | | | | | | |
| 6E | Methyl-β-cyclodextrin | 3 | BYK | 3 | Water-soluble | 5 | — | — | 10 | Remainder | 1 |
| | | | 348 | | resin 1 | | | | | | |
| 7E | Methyl-β-cyclodextrin | 3 | BYK | 6 | — | — | Particulate | 5 | 10 | Remainder | 0.5 |
| | | | 349 | | | | resin 1 | | | | |
| 8E | Methyl-β-cyclodextrin | 7.5 | BYK | 15 | — | — | Particulate | 5 | 10 | Remainder | 0.5 |
| | | | 331 | | | | resin 1 | | | | |
| 9E | α-cyclodextrin | 1.5 | BYK | 3 | — | — | Particulate | 2 | 10 | Remainder | 0.5 |
| | | | 347 | | | | resin 1 | | | | |
| 10E | β-cyclodextrin | 0.2 | BYK | 0.5 | — | — | Particulate | 15 | 10 | Remainder | 0.4 |
| | | | 347 | | | | resin 1 | | | | |
| 11E | γ-cyclodextrin | 1.5 | BYK | 3 | Water-soluble | 1 | — | — | 10 | Remainder | 0.5 |
| | | | 347 | | resin 1 | | | | | | |
| 12E | Hydroxypropyl-β- | 30 | BYK | 5 | Water-soluble | 10 | — | — | 10 | Remainder | 6 |
| | cyclodextrin | | 347 | | resin 1 | | | | | | |
| 13E | Maltosyl-β-cyclodextrin | 15 | BYK | 3 | Water-soluble | 5 | — | — | 10 | Remainder | 5 |
| | | | 347 | | resin 1 | | | | | | |
| 14E | 4-Sulfocalix[6]arene | 1.5 | BYK | 3 | Water-soluble | 5 | — | — | 10 | Remainder | 0.5 |
| | | | 347 | | resin 1 | | | | | | |
| 15E | Bovine serum albumin | 1.5 | BYK | 3 | Water-soluble | 5 | — | — | 10 | Remainder | 0.5 |
| | | | 347 | | resin 1 | | | | | | |
| 16E | Methyl-β-cyclodextrin | 4 | BYK | 0.5 | Water-soluble | 5 | — | — | 10 | Remainder | 8 |
| | | | 347 | | resin 1 | | | | | | |
| 17E | Methyl-β-cyclodextrin | 5 | BYK | 0.5 | Water-soluble | 5 | — | — | 10 | Remainder | 10 |
| | | | 347 | | resin 1 | | | | | | |
| 18E | Methyl-β-cyclodextrin | 0.75 | BYK | 3 | Water-soluble | 5 | — | — | 10 | Remainder | 0.25 |
| | | | 347 | | resin 1 | | | | | | |
| 19E | — | — | BYK | 3 | Water-soluble | 5 | — | — | 10 | Remainder | 0 |
| | | | 347 | | resin 1 | | | | | | |
| 20E | Calix[6]arene | 1.5 | BYK | 3 | Water-soluble | 5 | — | — | 10 | Remainder | 0.5 |
| | | | 347 | | resin 1 | | | | | | |

TABLE 2-4

| | | | Nonionic | | | | | | | |
|---|---|---|---|---|---|---|---|---|---|---|
| | Inclusion compound | | surfactant | | Reactant | | KOH | Glycerol | | |
| Liquid | | Content | | Content | | Content | Content | Content | | |
| composition | Type | A (%) | Type | C (%) | Type | (%) | (%) | (%) | Water | A/C |
| 1F | Methyl-β-cyclodextrin | 5 | BYK | 10 | Glutaric | 30 | 5 | 10 | Remainder | 0.5 |
| | | | 347 | | acid | | | | | |
| 2F | Methyl-β-cyclodextrin | 5 | BYK | 10 | Citric | 30 | 5 | 10 | Remainder | 0.5 |
| | | | 347 | | acid | | | | | |
| 3F | Methyl-β-cyclodextrin | 5 | BYK | 10 | Malic | 30 | 5 | 10 | Remainder | 0.5 |
| | | | 347 | | acid | | | | | |
| 4F | Methyl-β-cyclodextrin | 5 | BYK | 15 | Malonic | 30 | 5 | 10 | Remainder | 0.33 |
| | | | 347 | | acid | | | | | |
| 5F | Methyl-β-cyclodextrin | 5 | BYK | 10 | Ca | 3 | — | 10 | Remainder | 0.5 |
| | | | 347 | | nitrate | | | | | |
| 6F | Methyl-β-cyclodextrin | 5 | BYK | 10 | Ca | 3 | — | 10 | Remainder | 0.5 |
| | | | 347 | | chloride | | | | | |
| 7F | Methyl-β-cyclodextrin | 6 | BYK | 12 | Glutaric | 30 | 5 | 10 | Remainder | 0.5 |
| | | | 333 | | acid | | | | | |
| 8F | Methyl-β-cyclodextrin | 10 | BYK | 30 | Glutaric | 30 | 5 | 10 | Remainder | 0.33 |
| | | | 3455 | | acid | | | | | |
| 9F | Methyl-β-cyclodextrin | 6 | BYK | 20 | Glutaric | 30 | 5 | 10 | Remainder | 0.3 |
| | | | 348 | | acid | | | | | |
| 10F | Methyl-β-cyclodextrin | 6 | BYK | 6 | Glutaric | 30 | 5 | 10 | Remainder | 1 |
| | | | 349 | | acid | | | | | |
| 11F | Methyl-β-cyclodextrin | 6 | BYK | 9 | Glutaric | 30 | 5 | 10 | Remainder | 0.67 |
| | | | 331 | | acid | | | | | |
| 12F | α-cyclodextrin | 1.5 | BYK | 1.5 | Glutaric | 30 | 5 | 10 | Remainder | 1 |
| | | | 347 | | acid | | | | | |
| 13F | β-cyclodextrin | 1 | BYK | 4 | Glutaric | 30 | 5 | 10 | Remainder | 0.25 |
| | | | 347 | | acid | | | | | |
| 14F | γ-cyclodextrin | 1.5 | BYK | 3 | Glutaric | 30 | 5 | 10 | Remainder | 0.5 |
| | | | 347 | | acid | | | | | |
| 15F | Hydroxypropyl-β- | 30 | BYK | 10 | Glutaric | 30 | 5 | 10 | Remainder | 3 |
| | cyclodextrin | | 347 | | acid | | | | | |
| 16F | Maltosyl-β-cyclodextrin | 15 | BYK | 3 | Glutaric | 30 | 5 | 10 | Remainder | 5 |
| | | | 347 | | acid | | | | | |
| 17F | 4-Sulfocalix[6]arene | 1.5 | BYK | 3 | Ca | 3 | — | 10 | Remainder | 0.5 |
| | | | 347 | | nitrate | | | | | |
| 18F | Bovine serum albumin | 1.5 | BYK | 3 | Ca | 3 | — | 10 | Remainder | 0.5 |
| | | | 347 | | chloride | | | | | |
| 19F | Methyl-β-cyclodextrin | 4 | BYK | 0.5 | Glutaric | 30 | 5 | 10 | Remainder | 8 |
| | | | 347 | | acid | | | | | |
| 20F | Methyl-β-cyclodextrin | 5 | BYK | 0.5 | Glutaric | 30 | 5 | 10 | Remainder | 10 |
| | | | 347 | | acid | | | | | |
| 21F | Methyl-β-cyclodextrin | 0.75 | BYK | 3 | Glutaric | 30 | 5 | 10 | Remainder | 0.25 |
| | | | 347 | | acid | | | | | |
| 22F | — | — | BYK | 3 | Glutaric | 30 | | 10 | Remainder | 0 |
| | | | 347 | | acid | | | | | |
| 23F | Calix[6]arene | 1.5 | BYK | 3 | Glutaric | 30 | | 10 | Remainder | 0.5 |
| | | | 347 | | acid | | | | | |

Image Recording

Recording Medium

Images were recorded on the following recording media.

Trade name “New V Matt” (coated paper, manufactured by Mitsubishi Paper Mills)

Trade name “Mirror Coat G” (cast-coated paper, manufactured by Oji Paper Co., Ltd.)

Trade name “GL-101” (photo paper for ink jet recording, manufactured by Canon)

Trade name “PB PAPER GF-500” (plain paper, manufactured by Canon)

“Intermediate transfer member” (prepared by coating a PET sheet having a thickness of 0.5 mm with a silicone rubber having a rubber hardness of 40° and a thickness of 0.2 mm (trade name “KE12”, manufactured by Shin-Etsu Chemical Co., Ltd.))

Ink Jet Recording Apparatus

An ink jet recording apparatus having the structure shown in FIGURE was used to record an image on a recording medium by high speed printing at 1 m/s. The ink jet recording apparatus shown in FIGURE includes a recording head 4, a conveyer stage 2 on which a recording medium 1 is placed, and a liquid composition application unit 3. The conveyer stage 2 conveys the recording medium 1 by the action of a conveyance mechanism (not shown) in the arrow direction. The liquid composition application unit 3 is a unit for applying a liquid composition containing a reactant and the like to the recording medium, as necessary, when a two-liquid reaction system is used to record images, for example. Specific examples of the liquid composition application unit 3 include rollers and liquid ejection heads (recording heads). With this ink jet recording apparatus, the condition in which 3.0 ng of an ink droplet is applied to a unit area of 1/1,200 inch× 1/1,200 inch at a resolution of 1,200 dpi×1,200 dpi is defined as “a recording duty of 100%”.

### Examples 1A to 22A, Comparative Examples 1A to 2A

### [1] Recording Method while Heating a Recording Medium

The conveyer stage 2 of the ink jet recording apparatus (FIGURE) was heated, and accordingly the recording medium 1 was heated to 60° C. From the recording head 4, the liquid composition was ejected and applied to the recording medium 1 to record a solid image with a recording duty of 100% in an area of 5 cm×5 cm. Here, the recording head 4 was not heated. Combinations of the liquid compositions and the recording media used are shown in Table 1-5.

### [2] Recording Method while Heating a Recording Head

The recording head 4 (FIGURE) was heated by a heater, and the temperature of the ejection part was measured with a noncontact thermometer. After the confirmation of a temperature of 60° C., the liquid composition was ejected and applied to the recording medium 1 to record a solid image with a recording duty of 100% in an area of 5 cm×5 cm. Here, the conveyer stage 2 was not heated. Combinations of the liquid compositions and the recording media used are shown in Table 1-5.

### Examples 1B to 22B, Comparative Examples 1B and 2B

### [1] Recording Method while Heating a Recording Medium

An ink jet recording apparatus equipped with a liquid ejection head (recording head) as the liquid composition application unit 3 (FIGURE) was used. The conveyer stage 2 of the ink jet recording apparatus was heated, and accordingly the recording medium 1 was heated to 60° C. The liquid ejection head was used to apply the liquid composition containing a reactant to the recording medium 1, and then the recording medium 1 was conveyed in the arrow direction. Here, the liquid ejection head was not heated. Next, the liquid composition containing a pigment was ejected from the recording head 4 and applied to the recording medium 1 to record a solid image with a recording duty of 100% in an area of 5 cm×5 cm. Combinations of the liquid compositions and the recording media used are shown in Table 1-6.

### [2] Recording Method while Heating a Recording Head

An ink jet recording apparatus equipped with a liquid ejection head (recording head) as the liquid composition application unit 3 (FIGURE) was used. The liquid ejection head was heated by a heater, and the temperature of the ejection part was measured with a noncontact thermometer. After the confirmation of a temperature of 60° C., the liquid composition containing a reactant was applied to the recording medium 1. The recording medium 1 was conveyed in the arrow direction, and then the liquid composition containing a pigment was ejected from the recording head 4 and applied to the recording medium 1 to record a solid image with a recording duty of 100% in an area of 5 cm×5 cm. Here, the conveyer stage 2 and the recording head 4 were not heated. Combinations of the liquid compositions and the recording media used are shown in Table 1-6.

### Example 23B

### [1] Recording Method while Heating a Recording Medium

An ink jet recording apparatus equipped with rollers as the liquid composition application unit 3 (FIGURE) was used. The conveyer stage 2 of the ink jet recording apparatus was heated, and accordingly the recording medium 1 was heated to 60° C. The rollers were used to apply the liquid composition containing a reactant to the recording medium 1, and then the recording medium 1 was conveyed in the arrow direction. Next, the liquid composition containing a pigment was ejected from the recording head 4 and applied to the recording medium 1 to record a solid image with a recording duty of 100% in an area of 5 cm×5 cm. The combination of the liquid compositions and the recording medium used is shown in Table 1-6.

Evaluation of Images

The recorded solid images were visually observed, and the image conditions were evaluated based on the following criteria. The evaluation results are shown in Tables 1-5 and 1-6. In the present invention, a sample evaluated as “A” or “B” was regarded as an acceptable level, and a sample evaluated as “C” was regarded as an unacceptable level.

A: A good solid image without nonuniformity or color skip is recorded.
B: A usable solid image partly having nonuniformity or color skip is recorded.
C: Nonuniformity or color skip is observed, and a good solid image is not recorded.

TABLE 1-5

| | | | Evaluation | |
|---|---|---|---|---|
| | | | Heating | |
| | | | re- | |
| | | Recording | cording | Heating |
| | Liquid composition | medium | medium | head |
| Example 1A | Liquid composition | Mirror Coat G | A | A |
| | 1A | | | |
| Example 2A | Liquid composition | Mirror Coat G | A | A |
| | 2A | | | |
| Example 3A | Liquid composition | Mirror Coat G | A | A |
| | 3A | | | |
| Example 4A | Liquid composition | Mirror Coat G | A | A |
| | 4A | | | |
| Example 5A | Liquid composition | Mirror Coat G | A | A |
| | 5A | | | |
| Example 6A | Liquid composition | Mirror Coat G | A | A |
| | 6A | | | |
| Example 7A | Liquid composition | Mirror Coat G | A | A |
| | 7A | | | |
| Example 8A | Liquid composition | Mirror Coat G | A | A |
| | 8A | | | |
| Example 9A | Liquid composition | Mirror Coat G | A | A |
| | 9A | | | |
| Example 10A | Liquid composition | Mirror Coat G | A | A |
| | 10A | | | |
| Example 11A | Liquid composition | Mirror Coat G | A | A |
| | 11A | | | |
| Example 12A | Liquid composition | Mirror Coat G | A | A |
| | 12A | | | |
| Example 13A | Liquid composition | Mirror Coat G | B | B |
| | 13A | | | |
| Example 14A | Liquid composition | Mirror Coat G | B | B |
| | 14A | | | |
| Example 15A | Liquid composition | Mirror Coat G | A | A |
| | 15A | | | |
| Example 16A | Liquid composition | Mirror Coat G | B | B |
| | 16A | | | |
| Example 17A | Liquid composition | Mirror Coat G | A | A |
| | 17A | | | |
| Example 19A | Liquid composition | New V Matt | A | A |
| | 1A | | | |
| Example 20A | Liquid composition | Intermediate | A | A |
| | 1A | transfer | | |
| | | member | | |
| Example 21A | Liquid composition | GL-101 | A | A |
| | 1A | | | |
| Example 22A | Liquid composition | PB PAPER | A | A |
| | 1A | GF-500 | | |
| Comparative | Liquid composition | Mirror Coat G | C | C |
| Example 1A | 18A | | | |
| Comparative | Liquid composition | Mirror Coat G | C | C |
| Example 2A | 19A | | | |

TABLE 1-6

| | Liquid | Liquid | Evaluation | | |
|---|---|---|---|---|---|
| | composition | composition | | Heating | |
| | containing | containing no | | recording | Heating |
| | reactant | reactant | Recording medium | medium | head |
| Example 1B | Liquid | Liquid | Mirror Coat G | A | A |
| | composition 1B | composition 1A | | | |
| Example 2B | Liquid | Liquid | Mirror Coat G | A | A |
| | composition 2B | composition 1A | | | |
| Example 3B | Liquid | Liquid | Mirror Coat G | A | A |
| | composition 3B | composition 1A | | | |
| Example 4B | Liquid | Liquid | Mirror Coat G | A | A |
| | composition 4B | composition 1A | | | |
| Example 5B | Liquid | Liquid | Mirror Coat G | A | A |
| | composition 5B | composition 1A | | | |
| Example 6B | Liquid | Liquid | Mirror Coat G | A | A |
| | composition 6B | composition 1A | | | |
| Example 7B | Liquid | Liquid | Mirror Coat G | A | A |
| | composition 7B | composition 1A | | | |
| Example 8B | Liquid | Liquid | Mirror Coat G | A | A |
| | composition 8B | composition 1A | | | |
| Example 9B | Liquid | Liquid | Mirror Coat G | A | A |
| | composition 9B | composition 1A | | | |
| Example 10B | Liquid | Liquid | Mirror Coat G | A | A |
| | composition 10B | composition 1A | | | |
| Example 11B | Liquid | Liquid | Mirror Coat G | A | A |
| | composition 11B | composition 1A | | | |
| Example 12B | Liquid | Liquid | Mirror Coat G | A | A |
| | composition 12B | composition 1A | | | |
| Example 13B | Liquid | Liquid | Mirror Coat G | A | A |
| | composition 13B | composition 1A | | | |
| Example 14B | Liquid | Liquid | Mirror Coat G | B | B |
| | composition 14B | composition 1A | | | |
| Example 15B | Liquid | Liquid | Mirror Coat G | B | B |
| | composition 15B | composition 1A | | | |
| Example 16B | Liquid | Liquid | Mirror Coat G | A | A |
| | composition 16B | composition 1A | | | |
| Example 17B | Liquid | Liquid | Mirror Coat G | B | B |
| | composition 17B | composition 1A | | | |
| Example 18B | Liquid | Liquid | Mirror Coat G | A | A |
| | composition 18B | composition 1A | | | |
| Example 19B | Liquid | Liquid | New V Matt | A | A |
| | composition 1B | composition 1A | | | |
| Example 20B | Liquid | Liquid | Intermediate | A | A |
| | composition 1B | composition 1A | transfer member | | |
| Example 21B | Liquid | Liquid | GL-101 | A | A |
| | composition 1B | composition 1A | | | |
| Example 22B | Liquid | Liquid | PB PAPER GF-500 | A | A |
| | composition 1B | composition 1A | | | |
| Example 23B | Liquid | Liquid | Mirror Coat G | A | — |
| | composition 1B | composition 1A | | | |
| Comparative | Liquid | Liquid | Mirror Coat G | C | C |
| Example 1B | composition 19B | composition 1A | | | |
| Comparative | Liquid | Liquid | Mirror Coat G | C | C |
| Example 2B | composition 20B | composition 1A | | | |

### Examples 1C to 20C, Comparative Examples 1C to 3C

### [1] Recording Method while Heating a Recording Medium

The conveyer stage 2 of the ink jet recording apparatus (FIGURE) was heated, and accordingly the recording medium 1 was heated to 60° C. The liquid composition containing a pigment was ejected from the recording head 4 and applied to the recording medium 1 to record a solid image with a recording duty of 100% in an area of 5 cm×5 cm. Here, the recording head 4 was not heated. Combinations of the liquid compositions and the recording media used are shown in Table 2-5.

### [2] Recording Method while Heating a Recording Head

The recording head 4 (FIGURE) was heated by a heater, and the temperature of the ejection part was measured with a noncontact thermometer. After the confirmation of a temperature of 60° C., the liquid composition containing a pigment was ejected and applied to the recording medium 1 to record a solid image with a recording duty of 100% in an area of 5 cm×5 cm. Here, the conveyer stage 2 was not heated. Combinations of the liquid compositions and the recording media used are shown in Table 2-5.

### Examples 1D to 19D, Comparative Examples 1D and 2D

### [1] Recording Method while Heating a Recording Medium

The conveyer stage 2 of the ink jet recording apparatus (FIGURE) was heated, and accordingly the recording medium 1 was heated to 60° C. From the recording head 4, the liquid composition containing a dye was ejected and applied to the recording medium 1 to record a solid image with a recording duty of 100% in an area of 5 cm×5 cm. Here, the recording head 4 was not heated. Combinations of the liquid compositions and the recording media used are shown in Table 2-6.

### [2] Recording Method while Heating a Recording Head

The recording head 4 (FIGURE) was heated by a heater, and the temperature of the ejection part was measured with a noncontact thermometer. After the confirmation of a temperature of 60° C., the liquid composition containing a dye was ejected and applied to the recording medium 1 to record a solid image with a recording duty of 100% in an area of 5 cm×5 cm. Here, the conveyer stage 2 was not heated. Combinations of the liquid compositions and the recording media used are shown in Table 2-6.

### Examples 1E to 22E, Comparative Examples 1E and 2E

### [1] Recording Method while Heating a Recording Medium

The conveyer stage 2 of the ink jet recording apparatus (FIGURE) was heated, and accordingly the recording medium 1 was heated to 60° C. From the recording head 4, the liquid composition containing no coloring material and containing at least one of a water-soluble resin and a particulate resin was ejected and applied to the recording medium 1 to record a solid image with a recording duty of 100% in an area of 5 cm×5 cm. Here, the recording head 4 was not heated. Combinations of the liquid compositions and the recording media used are shown in Table 2-7.

### [2] Recording Method while Heating a Recording Head

The recording head 4 (FIGURE) was heated by a heater, and the temperature of the ejection part was measured with a noncontact thermometer. After the confirmation of a temperature of 60° C., the liquid composition containing no coloring material and containing at least one of a water-soluble resin and a particulate resin was ejected and applied to the recording medium 1 to record a solid image with a recording duty of 100% in an area of 5 cm×5 cm. Here, the conveyer stage 2 was not heated. Combinations of the liquid compositions and the recording media used are shown in Table 2-7.

### Examples 1F to 25F, Comparative Examples 1F to 3F

### [1] Recording Method while Heating a Recording Medium

An ink jet recording apparatus equipped with a liquid ejection head (recording head) as the liquid composition application unit 3 (FIGURE) was used. The conveyer stage 2 of the ink jet recording apparatus was heated, and accordingly the recording medium 1 was heated to 60° C. The liquid ejection head was used to apply the liquid composition containing a reactant to the recording medium 1, and then the recording medium 1 was conveyed in the arrow direction. Here, the liquid ejection head was not heated. Next, the liquid composition containing a pigment was ejected from the recording head 4 and applied to the recording medium 1 to record a solid image with a recording duty of 100% in an area of 5 cm×5 cm. Combinations of the liquid compositions and the recording media used are shown in Table 2-8.

### [2] Recording Method while Heating a Recording Head

An ink jet recording apparatus equipped with a liquid ejection head (recording head) as the liquid composition application unit 3 (FIGURE) was used. The liquid ejection head was heated by a heater, and the temperature of the ejection part was measured with a noncontact thermometer. After the confirmation of a temperature of 60° C., the liquid composition containing a reactant was applied to the recording medium 1. The recording medium 1 was conveyed in the arrow direction, and then the liquid composition containing a pigment was ejected from the recording head 4 and applied to the recording medium 1 to record a solid image with a recording duty of 100% in an area of 5 cm×5 cm. Here, the conveyer stage 2 and the recording head 4 were not heated. Combinations of the liquid compositions and the recording media used are shown in Table 2-8.

### Example 26F

### [1] Recording Method while Heating a Recording Medium

An ink jet recording apparatus equipped with rollers as the liquid composition application unit 3 (FIGURE) was used. The conveyer stage 2 of the ink jet recording apparatus was heated, and accordingly the recording medium 1 was heated to 60° C. The rollers were used to apply the liquid composition containing a reactant to the recording medium 1, and then the recording medium 1 was conveyed in the arrow direction. Next, the liquid composition containing a pigment was ejected from the recording head 4 and applied to the recording medium 1 to record a solid image with a recording duty of 100% in an area of 5 cm×5 cm. The combination of the liquid compositions and the recording medium used is shown in Table 2-8.

Evaluation of Images

The recorded solid images were visually observed, and the image conditions were evaluated based on the following criteria. The evaluation results are shown in Tables 2-5 to 2-8. In the present invention, a sample evaluated as “A” or “B” was regarded as an acceptable level, and a sample evaluated as “C” was regarded as an unacceptable level.

A: A good solid image without nonuniformity or color skip is recorded.
B: A usable solid image partly having nonuniformity or color skip is recorded.
C: Nonuniformity or color skip is observed, and a good solid image is not recorded.

TABLE 2-5

| | | | Evaluation | |
|---|---|---|---|---|
| | | | of images | |
| | | | Heating | |
| | | | re- | |
| | Liquid composition | Recording | cording | Heating |
| | containing pigment | medium | medium | head |
| Example 1C | Liquid composition | Mirror Coat G | A | A |
| | 1C | | | |
| Example 2C | Liquid composition | Mirror Coat G | A | A |
| | 2C | | | |
| Example 3C | Liquid composition | Mirror Coat G | A | A |
| | 3C | | | |
| Example 4C | Liquid composition | Mirror Coat G | A | A |
| | 4C | | | |
| Example 5C | Liquid composition | Mirror Coat G | B | B |
| | 5C | | | |
| Example 6C | Liquid composition | Mirror Coat G | A | A |
| | 6C | | | |
| Example 7C | Liquid composition | Mirror Coat G | A | A |
| | 7C | | | |
| Example 8C | Liquid composition | Mirror Coat G | A | A |
| | 8C | | | |
| Example 9C | Liquid composition | Mirror Coat G | A | A |
| | 9C | | | |
| Example 10C | Liquid composition | Mirror Coat G | A | A |
| | 10C | | | |
| Example 11C | Liquid composition | Mirror Coat G | A | A |
| | 11C | | | |
| Example 12C | Liquid composition | Mirror Coat G | A | A |
| | 12C | | | |
| Example 13C | Liquid composition | Mirror Coat G | B | B |
| | 13C | | | |
| Example 14C | Liquid composition | Mirror Coat G | B | B |
| | 14C | | | |
| Example 15C | Liquid composition | Mirror Coat G | A | A |
| | 15C | | | |
| Example 16C | Liquid composition | Mirror Coat G | B | B |
| | 16C | | | |
| Example 17C | Liquid composition | New V Matt | A | A |
| | 1C | | | |
| Example 18C | Liquid composition | Intermediate | A | A |
| | 1C | transfer | | |
| | | member | | |
| Example 19C | Liquid composition | GL-101 | A | A |
| | 1C | | | |
| Example 20C | Liquid composition | PB PAPER | A | A |
| | 1C | GF-500 | | |
| Comparative | Liquid composition | Mirror Coat G | C | C |
| Example 1C | 17C | | | |
| Comparative | Liquid composition | Mirror Coat G | C | C |
| Example 2C | 18C | | | |
| Comparative | Liquid composition | Mirror Coat G | C | C |
| Example 3C | 19C | | | |

TABLE 2-6

| | | | Evaluation | |
|---|---|---|---|---|
| | | | of images | |
| | | | Heating | |
| | | | re- | |
| | Liquid composition | Recording | cording | Heating |
| | containing dye | medium | medium | head |
| Example 1D | Liquid composition | Mirror Coat G | A | A |
| | 1D | | | |
| Example 2D | Liquid composition | Mirror Coat G | A | A |
| | 2D | | | |
| Example 3D | Liquid composition | Mirror Coat G | A | A |
| | 3D | | | |
| Example 4D | Liquid composition | Mirror Coat G | A | A |
| | 4D | | | |
| Example 5D | Liquid composition | Mirror Coat G | A | A |
| | 5D | | | |
| Example 6D | Liquid composition | Mirror Coat G | A | A |
| | 6D | | | |
| Example 7D | Liquid composition | Mirror Coat G | A | A |
| | 7D | | | |
| Example 8D | Liquid composition | Mirror Coat G | A | A |
| | 8D | | | |
| Example 9D | Liquid composition | Mirror Coat G | B | B |
| | 9D | | | |
| Example 10D | Liquid composition | Mirror Coat G | A | A |
| | 10D | | | |
| Example 11D | Liquid composition | Mirror Coat G | A | A |
| | 11D | | | |
| Example 12D | Liquid composition | Mirror Coat G | B | B |
| | 12D | | | |
| Example 13D | Liquid composition | Mirror Coat G | B | B |
| | 13D | | | |
| Example 14D | Liquid composition | Mirror Coat G | A | A |
| | 14D | | | |
| Example 15D | Liquid composition | Mirror Coat G | B | B |
| | 15D | | | |
| Example 16D | Liquid composition | New V Matt | A | A |
| | 1D | | | |
| Example 17D | Liquid composition | Intermediate | A | A |
| | 1D | transfer | | |
| | | member | | |
| Example 18D | Liquid composition | GL-101 | A | A |
| | 1D | | | |
| Example 19D | Liquid composition | PB PAPER | A | A |
| | 1D | GF-500 | | |
| Comparative | Liquid composition | Mirror Coat G | C | C |
| Example 1D | 16D | | | |
| Comparative | Liquid composition | Mirror Coat G | C | C |
| Example 2D | 17D | | | |

TABLE 2-7

| | | | Evaluation | |
|---|---|---|---|---|
| | | | of images | |
| | | | Heating | |
| | Liquid composition | | re- | |
| | containing no | Recording | cording | Heating |
| | coloring material | medium | medium | head |
| Example 1E | Liquid composition | Mirror Coat G | A | A |
| | 1E | | | |
| Example 2E | Liquid composition | Mirror Coat G | A | A |
| | 2E | | | |
| Example 3E | Liquid composition | Mirror Coat G | A | A |
| | 3E | | | |
| Example 4E | Liquid composition | Mirror Coat G | A | A |
| | 4E | | | |
| Example 5E | Liquid composition | Mirror Coat G | B | B |
| | 5E | | | |
| Example 6E | Liquid composition | Mirror Coat G | A | A |
| | 6E | | | |
| Example 7E | Liquid composition | Mirror Coat G | A | A |
| | 7E | | | |
| Example 8E | Liquid composition | Mirror Coat G | A | A |
| | 8E | | | |
| Example 9E | Liquid composition | Mirror Coat G | A | A |
| | 9E | | | |
| Example 10E | Liquid composition | Mirror Coat G | A | A |
| | 10E | | | |
| Example 11E | Liquid composition | Mirror Coat G | A | A |
| | 11E | | | |
| Example 12E | Liquid composition | Mirror Coat G | A | A |
| | 12E | | | |
| Example 13E | Liquid composition | Mirror Coat G | A | A |
| | 13E | | | |
| Example 14E | Liquid composition | Mirror Coat G | B | B |
| | 14E | | | |
| Example 15E | Liquid composition | Mirror Coat G | B | B |
| | 15E | | | |
| Example 16E | Liquid composition | Mirror Coat G | A | A |
| | 16E | | | |
| Example 17E | Liquid composition | Mirror Coat G | B | B |
| | 17E | | | |
| Example 18E | Liquid composition | Mirror Coat G | A | A |
| | 18E | | | |
| Example 19E | Liquid composition | New V Matt | A | A |
| | 1E | | | |
| Example 20E | Liquid composition | Intermediate | A | A |
| | 1E | transfer | | |
| | | member | | |
| Example 21E | Liquid composition | GL-101 | A | A |
| | 1E | | | |
| Example 22E | Liquid composition | PB PAPER | A | A |
| | 1E | GF-500 | | |
| Comparative | Liquid composition | Mirror Coat G | C | C |
| Example 1E | 19E | | | |
| Comparative | Liquid composition | Mirror Coat G | C | C |
| Example 2E | 20E | | | |

TABLE 2-8

| | | | | Evaluation of | |
|---|---|---|---|---|---|
| | | Liquid | | images | |
| | | composition | | Heating | |
| | Liquid composition | containing | Recording | recording | Heating |
| | containing reactant | pigment | medium | medium | head |
| Example 1F | Liquid composition | Liquid | Mirror Coat G | A | A |
| | 1F | composition 1C | | | |
| Example 2F | Liquid composition | Liquid | Mirror Coat G | A | A |
| | 2F | composition 1C | | | |
| Example 3F | Liquid composition | Liquid | Mirror Coat G | A | A |
| | 3F | composition 1C | | | |
| Example 4F | Liquid composition | Liquid | Mirror Coat G | A | A |
| | 4F | composition 1C | | | |
| Example 5F | Liquid composition | Liquid | Mirror Coat G | A | A |
| | 5F | composition 1C | | | |
| Example 6F | Liquid composition | Liquid | Mirror Coat G | A | A |
| | 6F | composition 1C | | | |
| Example 7F | Liquid composition | Liquid | Mirror Coat G | A | A |
| | 7F | composition 1C | | | |
| Example 8F | Liquid composition | Liquid | Mirror Coat G | A | A |
| | 8F | composition 1C | | | |
| Example 9F | Liquid composition | Liquid | Mirror Coat G | A | A |
| | 9F | composition 1C | | | |
| Example 10F | Liquid composition | Liquid | Mirror Coat G | A | A |
| | 10F | composition 1C | | | |
| Example 11F | Liquid composition | Liquid | Mirror Coat G | A | A |
| | 11F | composition 1C | | | |
| Example 12F | Liquid composition | Liquid | Mirror Coat G | A | A |
| | 12F | composition 1C | | | |
| Example 13F | Liquid composition | Liquid | Mirror Coat G | A | A |
| | 13F | composition 1C | | | |
| Example 14F | Liquid composition | Liquid | Mirror Coat G | A | A |
| | 14F | composition 1C | | | |
| Example 15F | Liquid composition | Liquid | Mirror Coat G | A | A |
| | 15F | composition 1C | | | |
| Example 16F | Liquid composition | Liquid | Mirror Coat G | A | A |
| | 16F | composition 1C | | | |
| Example 17F | Liquid composition | Liquid | Mirror Coat G | B | B |
| | 17F | composition 1C | | | |
| Example 18F | Liquid composition | Liquid | Mirror Coat G | B | B |
| | 18F | composition 1C | | | |
| Example 19F | Liquid composition | Liquid | Mirror Coat G | A | A |
| | 19F | composition 1C | | | |
| Example 20F | Liquid composition | Liquid | Mirror Coat G | B | B |
| | 20F | composition 1C | | | |
| Example 21F | Liquid composition | Liquid | Mirror Coat G | A | A |
| | 21F | composition 1C | | | |
| Example 22F | Liquid composition | Liquid | New V Matt | A | A |
| | 1F | composition 1C | | | |
| Example 23F | Liquid composition | Liquid | Intermediate | A | A |
| | 1F | composition 1C | transfer | | |
| | | | member | | |
| Example 24F | Liquid composition | Liquid | GL-101 | A | A |
| | 1F | composition 1C | | | |
| Example 25F | Liquid composition | Liquid | PB PAPER GF- | A | A |
| | 1F | composition 1C | 500 | | |
| Example 26F | Liquid composition | Liquid | Mirror Coat G | A | — |
| | 1F | composition 1C | | | |
| Comparative | Liquid composition | Liquid | Mirror Coat G | C | C |
| Example 1F | 22F | composition 1C | | | |
| Comparative | Liquid composition | Liquid | Mirror Coat G | C | C |
| Example 2F | 23F | composition 1C | | | |
| Comparative | Liquid composition | Liquid | Mirror Coat G | C | C |
| Example 3F | 1F | composition 18C | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-113886, filed Jun. 4, 2015 and Japanese Patent Application No. 2015-113887, filed Jun. 4, 2015 which are hereby incorporated by reference herein in their entirety.

What is claimed is:

1. An image recording method comprising a step of applying a liquid composition to a recording medium, the liquid composition containing:
a fluorinated nonionic surfactant; and
a water-soluble inclusion compound.

2. The image recording method according to claim 1, wherein the inclusion compound is at least one of a cyclodextrin and a cyclodextrin derivative.

3. The image recording method according to claim 1, wherein a content (% by mass) of the inclusion compound is 8.0 times or less as much as a content (% by mass) of the nonionic surfactant in terms of mass ratio.

4. The image recording method according to claim 1, wherein the liquid composition further contains a coloring material.

5. The image recording method according to claim 1, wherein the liquid composition further contains a reactant that increases a viscosity of an ink containing a coloring material when the reactant comes into contact with the ink.

6. The image recording method according to claim 1, wherein the step of applying a liquid composition to a recording medium is a step ejecting the liquid composition from an ink jet recording head to apply the liquid composition to the recording medium.

7. The image recording method according to claim 6, wherein the liquid composition is ejected from the recording head having a temperature of 35° C. or more.

8. The image recording method according to claim 1, wherein the recording medium is a liquid-component-non-absorbable or -poorly-absorbable recording medium.

9. The image recording method according to claim 1, wherein the liquid composition is applied to the recording medium having a temperature of 35° C. or more.

10. The image recording method according to claim 1, wherein the recording medium is an intermediate transfer member.

11. A liquid composition comprising:
a fluorinated nonionic surfactant; and
a water-soluble inclusion compound.

12. An image recording method comprising a step of applying a liquid composition to a recording medium, the liquid composition containing:
a pigment;
a silicon-based nonionic surfactant; and
a water-soluble inclusion compound,
wherein a content (% by mass) of the nonionic surfactant is 0.5% by mass or more.

13. The image recording method according to claim 12, wherein the liquid composition further contains at least one of a water-soluble resin and a particulate resin.

14. The image recording method according to claim 12, wherein the liquid composition further contains a reactant that increases a viscosity of an ink containing a coloring material when the reactant comes into contact with the ink.

15. The image recording method according to claim 12, wherein a content (% by mass) of the nonionic surfactant is 0.5% by mass or more.

16. The image recording method according to claim 12, wherein the inclusion compound is at least one of a cyclodextrin and a cyclodextrin derivative.

17. The image recording method according to claim 12, wherein a content (% by mass) of the inclusion compound is 8.0 times or less as much as a content (% by mass) of the nonionic surfactant in terms of mass ratio.

18. An image recording method comprising a step of applying a liquid composition to a recording medium, the liquid composition containing:
a dye;
a silicon-based nonionic surfactant; and
a water-soluble inclusion compound.

19. An image recording method comprising a step of applying a liquid composition to a recording medium, the liquid composition containing:
a silicon-based nonionic surfactant; and
a water-soluble inclusion compound,
wherein the liquid composition contains no coloring material.

20. A liquid composition comprising:
a pigment;
a silicon-based nonionic surfactant; and
a water-soluble inclusion compound,
wherein a content (% by mass) of the nonionic surfactant is 0.5% by mass or more.

21. A liquid composition comprising:
a dye;
a silicon-based nonionic surfactant; and
a water-soluble inclusion compound.

22. A liquid composition comprising:
a silicon-based nonionic surfactant; and
a water-soluble inclusion compound,
wherein the liquid composition contains no coloring material.
